(19) United States
(12) Patent Application Publication
(10) Pub. No.: US 2020/0338595 A1
(43) Pub. Date: Oct. 29, 2020

(54) AUGER DISC FOR USE IN DISC SCREEN

(71) Applicant: Nicholas Davis, San Diego, CA (US)

(72) Inventor: Nicholas Davis, San Diego, CA (US)

(73) Assignee: CP Manufacturing, Inc., San Diego, CA (US)

(21) Appl. No.: 16/923,463

(22) Filed: Jul. 8, 2020

Related U.S. Application Data
(63) Continuation-in-part of application No. 16/724,245, filed on Dec. 21, 2019.
Application No. 16/724,245 is a continuation-in-part of application No. 16/546,136, filed on Aug. 20, 2019.
Application No. 16/546,136 is a continuation of application No. 16/193,815, filed on Nov. 16, 2018, now Pat. No. 10,406,560.
(60) Provisional application No. 62/883,611, filed on Aug. 6, 2019.
(60) Provisional application No. 63/036,754, filed on Jun. 9, 2020.
(60) Provisional application No. 63/036,881, filed on Jun. 9, 2020.
(60) Provisional application No. 62/932,080, filed on Nov. 7, 2019.
(60) Provisional application No. 62/912,574, filed on Oct. 8, 2019.
(60) Provisional application No. 62/814,107, filed on Mar. 5, 2019.
(60) Provisional application No. 62/739,692, filed on Oct. 1, 2018.

(51) Int. Cl. B07B 1/15; B07B 1/14; A01D 17/06; D21B 1/02

(52) U.S. Cl. CPC B07B 1/15; D21B 1/02; A01D 17/06; B07B 1/145

(57) ABSTRACT

A disc for use in a disc screen is disclosed. The auger disc includes a central longitudinal disc axis and a hub extending a length along the longitudinal disc axis. The longitudinal disc axis is coaxial with the center of the hub. The hub further includes a hub surface and a helical ridge structure extending away from the hub surface and twisting about the longitudinal axis at least 360 degrees. The auger disc has a disc rotation axis that is parallel to the central longitudinal axis and is offset from the center of the hub. The auger disc is constructed to rotate about the disc rotation axis.

### 1.0 TECHNICAL FIELD

The present invention relates generally to machines used to sort materials and mixed recyclable materials.

### 2.0 RELATED APPLICATIONS

This application claims priority to U.S. Patent Ser. No. 62/883611 titled “Auger Disc For Use in Disc Screen” filed on Aug. 6, 2019, to U.S. Patent Ser. No. 63/036754 titled “Auger Disc For Use in Disc Screen” filed on Jun. 9, 2020, to U.S. Patent Ser. No. 63/036881 titled “Auger Disc For Use in Disc Screen” filed on Jun. 9, 2020, to U.S. Patent Ser. No. 62/932080 titled “Amplified Ballistic Separator For Separating Material” filed on Nov. 7, 2019, and to U.S. Patent Ser. No. 62/912574 titled “Amplified Ballistic Separator For Separating Material” filed on Oct. 9, 2019. This application also claims priority as a continuation-in-part of U.S. patent 15 Ser. No. 16/546136 titled “Disc For Use in Disc Screen” filed on Aug. 20, 2019, which claims priority as a continuation of U.S. patent Ser. No. 16/193815 titled “Disc For Use In Disc Screen” filed on Nov. 16, 2018, now U.S. Pat. No. 10,406,560, which claims priority to U.S. Patent Ser. No. 62/739692 titled “High Amplitude Auger-Like Screening Device” filed on Oct. 1, 2018. This application also claims priority as a continuation-in-part of U.S. patent 20 Ser. No. 16/724245 titled “Amplified Ballistic Separator For Separating Material” filed on Dec. 21, 2019, which claims priority as the non-provisional of U.S. Patent Ser. No. 62/814107 titled “Amplified Ballistic Separator For Separating Material” filed on Mar. 5, 2019. The entire contents of these applications are incorporated herein by reference.

### 3.0 BACKGROUND

A bulk material screening device is a device which separates input material by size or shape. These screening devices are used in industries such as mining and aggregates, forestry, agriculture, and recycling to separate inbound materials into more valuable products. For example, in the solid waste and recycling industry, high value corrugated cardboard containers tend to be of a larger size than other recyclable material, and so can be separated from other materials based on this large size. Traditional screening devices include trommels, disc screens, and vibratory screens.

Trommel screens and vibratory screens utilize a static screening surface, consisting of a steel or polymer material with holes of a certain size, and then bring material into contact with the screening surface such that materials smaller than the holes pass through the screening surface, and material larger than the holes do not. These types of static screens are subject to operational and maintenance hazards when material builds up in or around the holes of the screening surface. This typically happens due to wet or stringy material. As material builds up around the holes, the hole size becomes smaller, and the nature of the screened material changes. Once the holes become too small, it becomes necessary to stop the machine so the screening surface can be cleaned.

A disc screen consists of a series or parallel rotors or shafts, with attached discs or stars, turned in concert such that a sufficiently consistent opening between the rotors is achieved as they are turned. Screening is achieved by constructing the rotors and discs such that the desired opening is achieved. The rotation of the rotors also drives the material forward, making it easier to bring new material into contact with the screening surface, allowing for smaller and cheaper machines to be used to accomplish the same task as passive screens. This type of active screening surface is not subject to the buildup of wet materials as described above. However, the rotors are extremely prone to wrapping on stringy materials. As each rotor is increasingly wrapped, the opening of the screening surface decreases due to wrapped material. Once the openings become too small, it is necessary to clean the machine by cutting the wrappings off with a chisel or knife. The prevalence of plastic bags and other stringy material within solid waste is a consistent challenge for the waste and recycling industry when using disc screens.

It is generally understood that many of the maintenance hazards for disc screens stop being an issue as the opening of the screen gets small enough that stringy material can no longer fit through the opening. This typically occurs at an opening size of approximately two inches. However, a screen with this size opening typically cannot accept any material larger than six inches or risk having the openings covered, or blinded, by the larger material, meaning these disc screens that don't suffer maintenance issue typically are located toward the end of a material processing line, coming into contact with materials after larger items have been removed.

When the aforementioned machines are used in particularly difficult material streams that present high levels of maintenance hazards, there is often a conveyor belt configured to allow human-powered sorting of materials placed before any machines to remove said hazards. This is typically called a “pre-sort”. Pre-sorting material before mechanical process is expensive as it takes many sorters to sift through the full burden depth of the material. Further, this pre-sort station is the most hazardous sort station to the human sorters as it receives all of the heterogeneous material. They are tasked with sorting large, heavy objects from in a moving pile, which can be up to 30″ away from them, while avoiding being stabbed by broken glass, sharp metal objects, and other sharp objects such as used hypodermic needles that would typically be found in the small fraction of material. For this reason, most workers at a pre-sort station utilize Kevlar or similar gloves to protect themselves, but this makes it even more difficult to lift the intended items, requiring additional sorters and additional expense to achieve a sufficient pre-sort such that the material screening devices do not constantly break down.

Another type of active material screening device consists of a series of parallel augers having interleaved flights with consistent spacing such that the opening between auger shafts and flights creates a screening surface. An auger is a central shaft with a rotating helical blade attached to the radial surface. As a helix is necessarily a projection on the surface of a cylinder with a constant angle between the tangent of the projection and a central axis, augers are traditionally round. In the application of a screening device made out of augers, the roundness of the auger and the consistent spacing of flights guarantees the adjacent augers do not collide.

Auger screens are beneficial in certain industries, such as screening of solid waste materials, where wrapping and plugging of traditional screening devices is a problem. This is because as material wraps on the auger shaft, the flights of the adjacent augers pushes the wrapped material off the shaft and prevents plugging and jamming. However, as augers are constrained to a circular shape, the current state of the art in auger screens does not provide any bouncing motion or material agitation so material does not sift toward the screening surface, limiting applications to where material can be singulated or reducing screening efficiency compared to disc screens, requiring much larger machines to be used to accomplish the same task. Further, as taught by Gunther in EP 1570 919 B1, this machine is very sensitive to the material feed configuration, requiring the machine to be fed laterally with a high speed belt such that material is flung onto the machine, rather than dropped, to minimize the sorting inefficiencies of having no agitation.

There are several different types of material agitation which a bulk screening device may utilize. For example, trommels utilize a tumbling style of agitation where material is lifted and flipped before landing on the screening surface. Disc screens agitate material both by striking the material from underneath and by the material bouncing on a screening surface, which rises and falls. Additional types of agitation a disc screen can use are shearing agitation, where adjacent discs are rotating at different speeds such that material which is in contact with both discs will rotate, and acceleration agitation, where each successive row of discs rotates at a higher speed such that tangled material is pulled apart when the front of the tangle moves faster than the back of the tangle.

It is not necessary to pre-sort an auger screen as it is with other screening devices, allowing it to be placed in front of the pre-sort. In the current state of the art, an auger screen with approximately an 8″ opening is placed before the pre-sort to screen out small and potentially hazardous items. The pre-sorters can then focus on the sorting of large items which are maintenance hazards without needing to worry about being stabbed by broken glass or hypodermic needles. This further allows fewer pre-sorters to be used to accomplish the same task as a traditional pre-sort. However, the auger screen is not suitable for final screening of materials, which is typically performed by a disc screen configured for the separation of old corrugated cardboard (OCC) from mixed recyclables. These machines have an approximately 12″×12″ opening with rotors on 20″ centers and an amplitude of agitation of 2″ to 5″. The high amplitude is necessary as OCC, such as the box of a flat screen television, is large and flat compared to the other items being sorted, and so other items tend to ride on top of the pieces of OCC. Further, a traditional disc screen typically requires an amplitude of at least 5% of the maximum particle size in order to achieve sufficient sifting action, with higher ratios being better. As such, an OCC Disc Screen with a 2″ amplitude would typically be used on items up to 40″ in diameter in any one dimension. With no agitation, the auger screen cannot be used for the screening of cardboard as too many riders pass over the screen.

Wess teaches another form of auger screen in U.S. Pat. No. 9,895,719. The auger flights in this machine consist of a series of “fingers” or “stars” protruding from a substrate. While in theory this will increase the surface speed of materials on the screen deck, the distal end of the fingers describes a circle, and there is too little space between the fingers to provide agitation, so it doesn't solve the primary weakness of existing auger screens. Further, this shape creates a pinching hazard, as the minimum distance between the helical shaped “flight”, and the opposite substrate varies continuously and sharply. This creates an impinging motion between the two mechanical parts that has a risk of causing a hard jam in the machine if a hard object, such as a rock, falls behind a finger and is forced into the opposing substrate by the following finger. While this risk is relatively small for small-opening screening devices and with the fingers placed tightly together, as the opening size is increased or as the fingers are moved further apart, larger and larger items can fall into the pocket created when the minimum distance is at a maximum, which can then be pinched by the following finger, creating a hard jam. As such, this limits the invention of Wess to the screening of small items, which are already screenable utilizing disc screens which have inherent agitation.

What is therefore needed is an auger-type disc for use in a disc screen that overcomes these deficiencies.

### 4.0 SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The apparatus, systems, and methods described herein elegantly solve the problems presented above. An auger-type disc for use in a disc screen is disclosed. The auger disc includes a central longitudinal disc axis and a hub extending a length along the longitudinal disc axis. The longitudinal disc axis is coaxial with the center of the hub. The hub further includes a hub surface and a helical ridge structure extending away from the hub surface and twisting about the longitudinal axis at least 360 degrees. The auger disc has a disc rotation axis that is parallel to the central longitudinal axis and is offset from the center of the hub. The auger disc is constructed to rotate about the disc rotation axis.

The hub may be circular or non-circular and may have multiple lobes. The helical ridge may extend away from the hub surface at a height that is constant along the length of the helical ridge.

A disc screen is also disclosed comprised of a first and second adjacent auger discs. Each disc may be constructed as summarized above, and the helical ridge structure from the first disc may be interleaved with the helical ridge structure of the second disc.

The helical ridge of the first disc may form a gap with the hub surface of the second disc, and when the two discs are rotated in the same direction, the width of the gap may remain substantially constant. The position of the gap may move along the direction of the longitudinal axis of the first disc and the position of the gap relative to the center of the hub of the first disc may not be substantially constant. The helical ridge of each disc may extend away from its respective hub surface at a height that is constant along the length of the helical ridge.

Additional aspects, alternatives and variations, as would be apparent to persons of skill in the art are also disclosed herein and are specifically contemplated as included as part of the invention. The invention is set forth only in the claims as allowed by the patent office in this or related applications, and the following summary descriptions of certain examples are not in any way to limit, define, or otherwise establish the scope of legal protection.

### 5.0 BRIEF DESCRIPTION OF THE DRAWINGS

The invention can be better understood with reference to the following figures. The components within the figures are not necessarily to scale, emphasis instead being placed on clearly illustrating example aspects of the invention. In the figures, like reference numerals designate corresponding parts throughout the different views and/or embodiments. It will be understood that certain components and details may not appear in the figures to assist in more clearly describing the invention.

FIG. 1A is an isometric view of a single eccentric auger disc.

FIG. 1B is an enlarged view of the end of the auger disc of FIG. 1A.

FIG. 1C is a side view of a single eccentric auger disc.

FIG. 2A is an isometric view of the drive side of an assembled auger disc screen using a plurality of interleaved eccentric auger discs.

FIG. 2B is isometric view of the discharge side of an assembled auger disc screen using a plurality of interleaved eccentric auger discs.

FIG. 2C is a top view of an assembled auger disc screen using a plurality of interleaved eccentric auger discs.

FIG. 3A is an end view of an assembled machine auger disc screen using a plurality of interleaved eccentric auger discs, each auger disc with its central axis displaced below the axis of rotation.

FIG. 3B is an end view of an assembled machine auger disc screen using a plurality of interleaved eccentric auger discs, each auger disc with its central axis displaced to the left of the axis of rotation.

FIG. 3C is an end view of an assembled machine auger disc screen using a plurality of interleaved eccentric auger discs, each auger disc with its central axis displaced above the axis of rotation.

FIG. 3D is an end view of an assembled machine auger disc screen using a plurality of interleaved eccentric auger discs, each auger disc with its central axis displaced to the right of the axis of rotation.

FIG. 4 illustrates the movement of a single eccentric auger disc to show the amplitude difference caused by the eccentricity.

FIG. 5 is an end view of an eccentric auger from the discharge end.

FIG. 6A is an isometric view of a single non-circular eccentric auger disc. Further disclosure of this non-circular auger disc is disclosed in U.S. patent Ser. No. 16/193815 now U.S. Pat. No. 10,406,560, incorporated herein by reference.

FIG. 6B is an enlarged view of the end of the auger disc of FIG. 6A.

FIG. 7A is an isometric view of a two-concentric shaft design with rotational adjustment in two degrees of freedom.

FIG. 7B is an enlarged view of the end of the two-concentric shaft design of FIG. 7A.

FIG. 8 is an isometric view of the two-concentric shaft design where the auger shaft has been adjustably rotated relative to the inner shaft as compared to FIG. 7A.

FIG. 9A is an isometric view of the two-concentric shaft design in an operational configuration in a first rotational position.

FIG. 9B is an isometric view of the two-concentric shaft design in an adjustment/installation configuration.

FIG. 9C is an isometric view of the two-concentric shaft design in an operational configuration in a second rotational position.

FIG. 10 is an isometric view of the auger shaft.

FIG. 11 is an isometric view of the inner shaft.

FIG. 12 is an isometric view of the end of the inner shaft where the stop may be attached.

FIG. 13 is an isometric view of the auger shaft mounted on the inner shaft, where the stop has been removed (i.e., in the adjustment/installation configuration).

FIG. 14 is an isometric view of the auger shaft mounted on the inner shaft, where the stop has been attached preventing the auger shaft from sliding relative to the inner shaft (i.e., in the operational configuration).

FIG. 15 is a cross-sectional view taken along line A-A of FIG. 14 illustrating the auger shaft mounted on the inner shaft, where the stop has been attached preventing the auger shaft from sliding relative to the inner shaft (i.e., in the operational configuration).

### 6.0 DETAILED DESCRIPTION OF EXAMPLE EMBODIMENTS

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, process operations well known to persons of skill in the art have not been described in detail in order not to obscure unnecessarily the present invention. Various techniques and mechanisms of the present invention will sometimes be described in singular form for clarity. However, it should be noted that some embodiments include multiple iterations of a technique or multiple mechanisms unless noted otherwise. Similarly, various steps of the methods shown and described herein are not necessarily performed in the order indicated, or performed at all in certain embodiments. Accordingly, some implementations of the methods discussed herein may include more or fewer steps than those shown or described. Further, the techniques and mechanisms of the present invention will sometimes describe a connection, relationship or communication between two or more entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection unless otherwise noted.

The following list of example features corresponds with the attached figures and is provided for ease of reference, where like reference numerals designate corresponding features throughout the specification and figures:

Auger Disc 10

Central Longitudinal Auger Disc Axis 15

Auger Disc Rotation Axis/Power Shaft Axis of Rotation 20

Bearing mount for Disc Axis of Rotation 21

Circular Hub 22

Hub Surface 23

Helical Ridge 25

Helical Ridge Height 26

Axis Offset 30

Helical Ridge 360 Degree Twist 35

Disc Screen 40

Gap 42

Gap Movement 44

Power Shaft 45

Gear 50

Interleaving of Auger Discs 52

Amplitude or Displacement (Horizontal and Vertical) 55

Non-circular Auger Disc with Two Lobes 110

Central Longitudinal Auger Disc Axis (Non-Circular) 115

Non-circular Auger Disc Axis of Rotation/Power Shaft Axis of Rotation 120

Non-Circular Hub 122

Hub Surface 123

Helical Ridge 125

Axis Offset (Non-Circular) 130

Hub Lobes 135

Auger Disc with a Two-Concentric Shaft Design 140

Outer Auger Shaft 145

Inner Shaft 150

Stop/Fastener/Plug 153

Stop/Fastener/Plug Threading 154

Self-Aligning Spline 155

Plurality of Relative Rotational Positions 157

First Degree of Freedom Adjustment 160

Second Degree of Freedom Adjustment 165

Slide During Adjustment 170

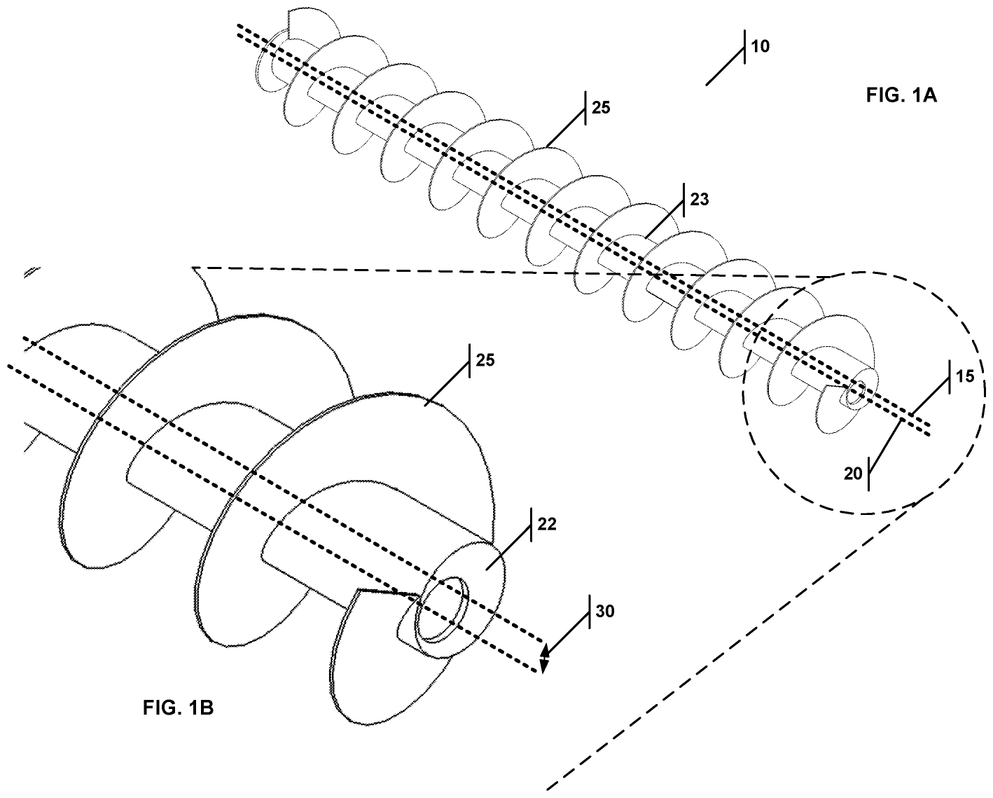

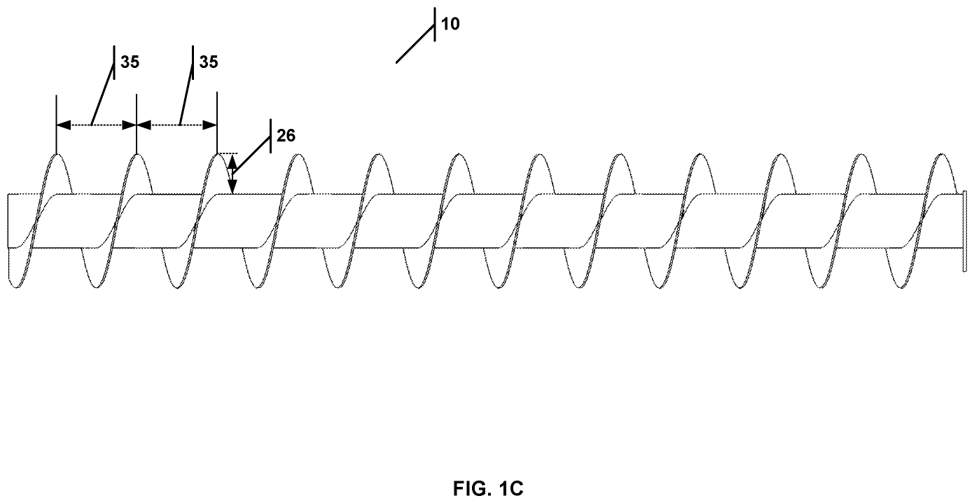

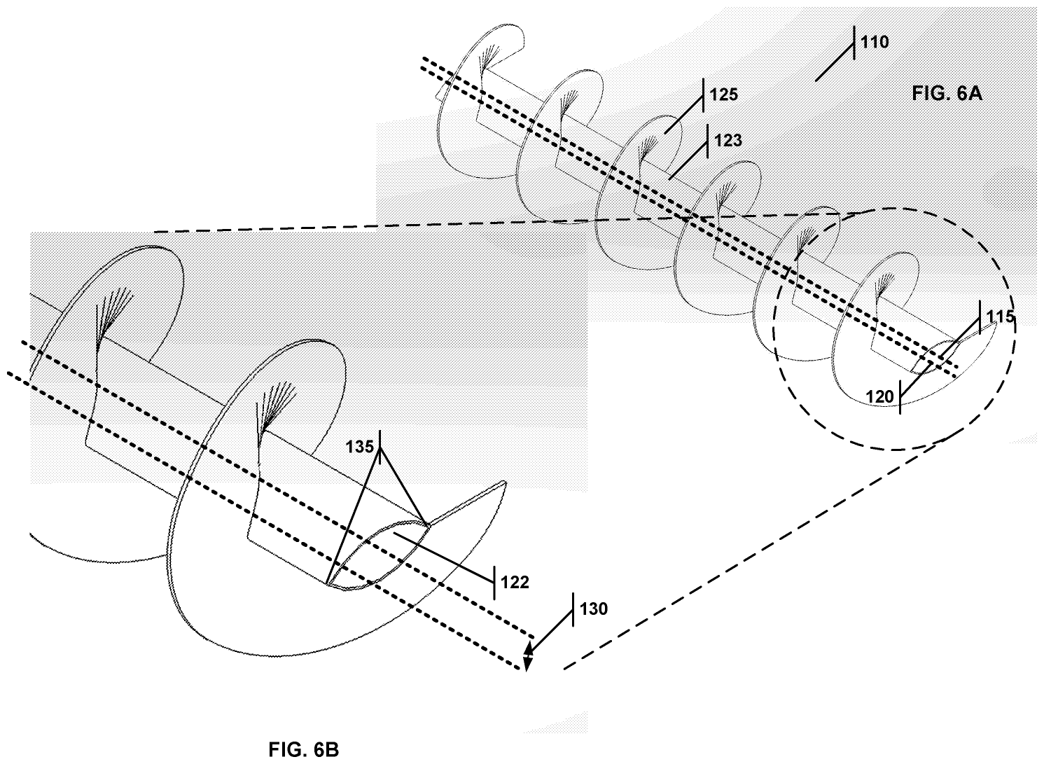

A novel auger disc for use in a disc screen is presented in FIGS. 1A and 1B. The novel auger disc 10 is distinct over the prior art in that it is eccentric and features varying amplitudes of vertical displacement. The auger disc 10 comprises a central longitudinal auger disc axis 15 and a hub 22 extending for a length along the longitudinal auger disc axis 15. The longitudinal auger disc axis 15 is coaxial with the center of the hub 22. The hub 22 itself comprises a hub surface 23, a helical ridge structure 25 extending away from the hub surface 23 and twisting about the longitudinal auger disc axis 15 at least 360 degrees, shown in FIG. 1C as element 35, and a disc rotation axis 20 that is parallel to the central longitudinal auger disc axis 15 and is offset 30 from the center of the hub 22 (FIGS. 1A and 1B). The auger disc 10 is constructed to rotate about the auger disc rotation axis 20. The hub of the auger disc 10 may be circular, as shown in FIGS. 1A-5B, or non-circular, as shown in FIGS. 6A-6B. If the hub 122 is non-circular, as presented in FIG. 6B, it may also comprise multiple lobes 135. The helical ridge structure 25 extends away from the hub surface 23 at a height 26, as shown in FIGS. 1A-1C. The height 26 may be constant for the length of the helical ridge 25, as seen in FIG. 1C.

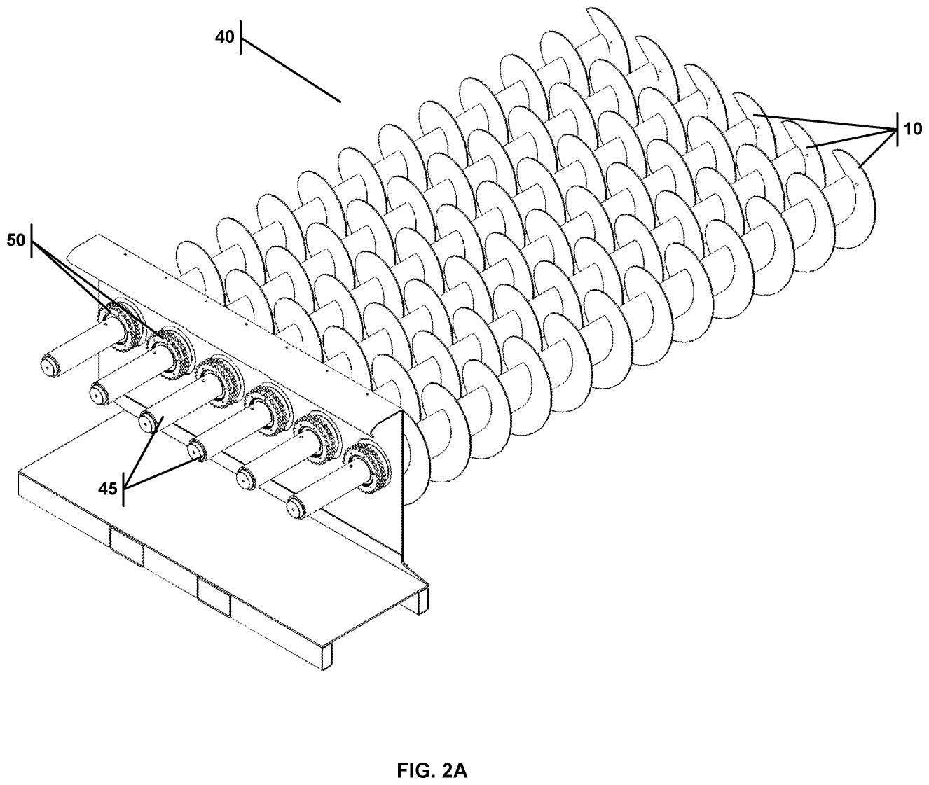

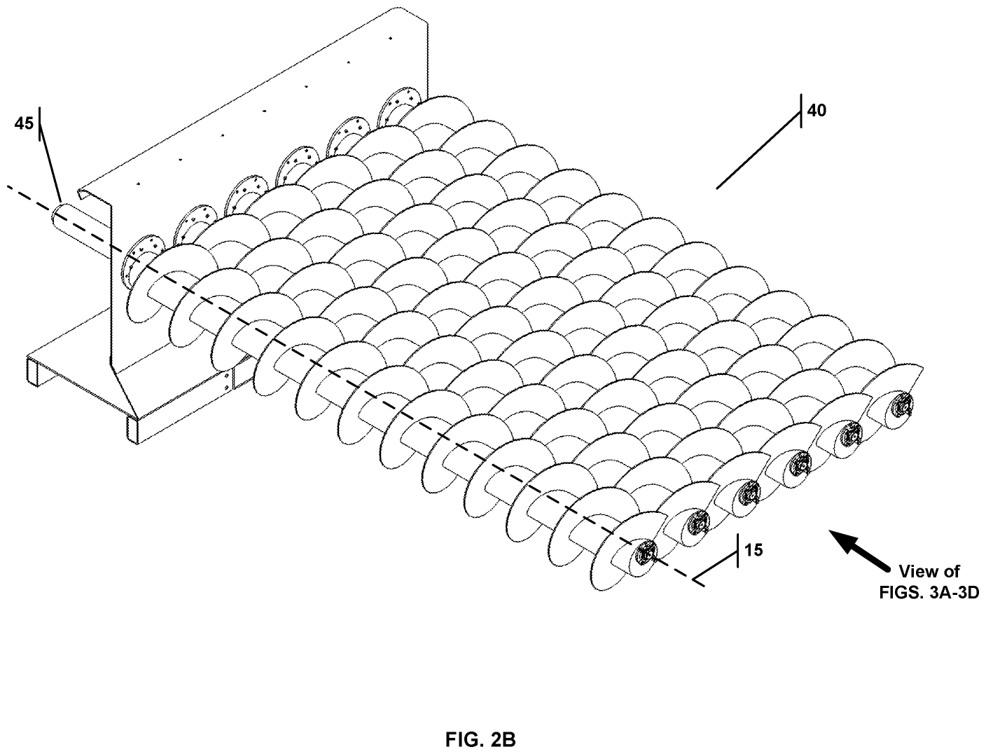

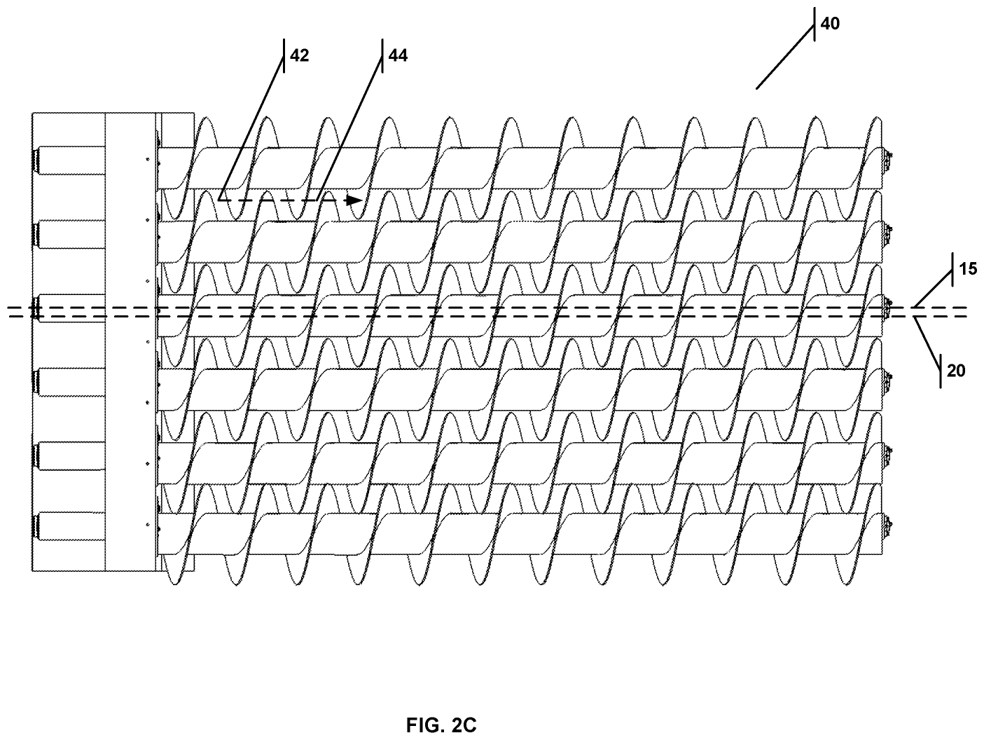

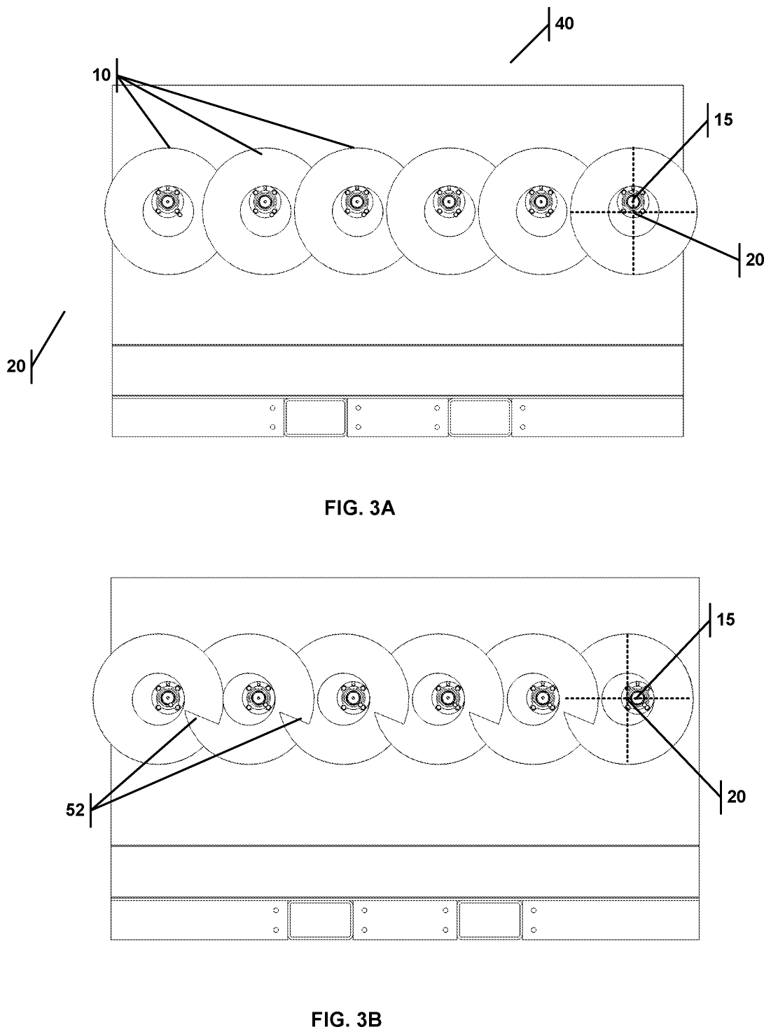

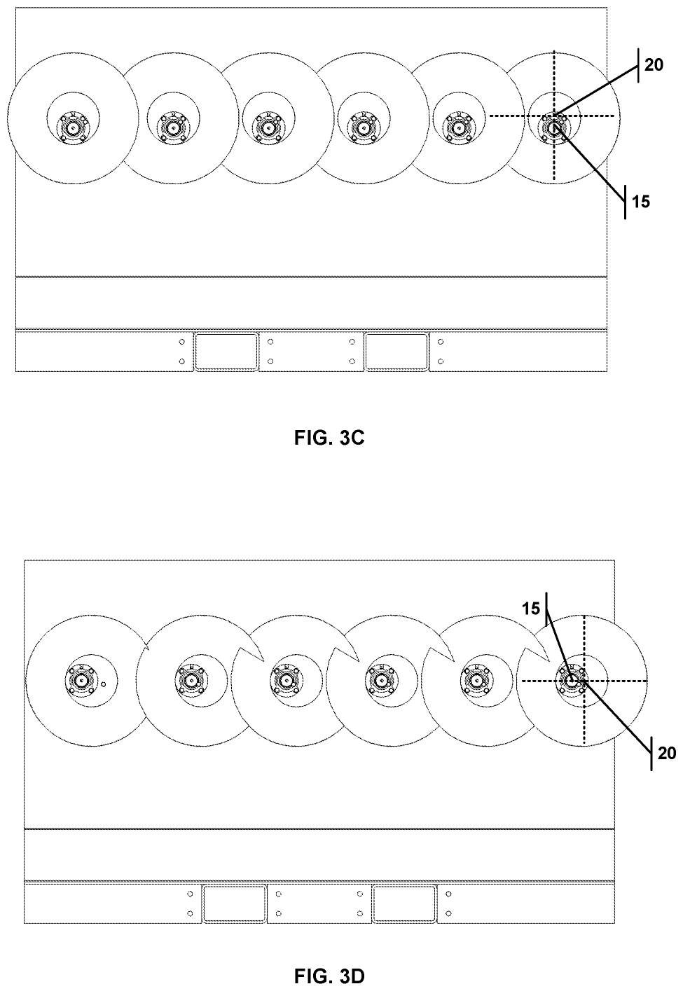

Turning now to FIGS. 2A-4, the auger disc 10 can be used in an auger type disc screen 40. FIG. 2A shows an isometric view of the disc screen 40 from the drive end, where each auger disc 10 is operated via a gear 50 and a power shaft 45. FIG. 2B illustrates the isometric view from the distal end of the disc screen 40. FIG. 2C shows a top view of the disc screen 40. Although FIGS. 2A-2C show six auger discs 10 being used, it should be obvious to one of skill in the art that any plurality of auger discs 10 may be used. The disc screen 40 has a first and second adjacent auger discs 10, each disc comprising a central longitudinal disc axis 15, a hub 22 extending a length along the longitudinal disc axis 15 that is coaxial with the center of the hub, the hub further comprising a hub surface 23, a helical ridge structure 25 extending away from the hub surface 23 and twisting about the longitudinal axis 15 by at least 360 degrees, and a disc rotation axis 20 that is parallel to the central longitudinal axis 15 and is offset 30 from the center of the hub 22, wherein the disc 10 is constructed to rotate about the disc rotation axis 20. In the disc screen 40, the helical ridge structure from the first disc is interleaved with the helical structure of the second disc. This interleaving 52 is shown in FIGS. 3A-3D, particularly FIGS. 3B and 3D.

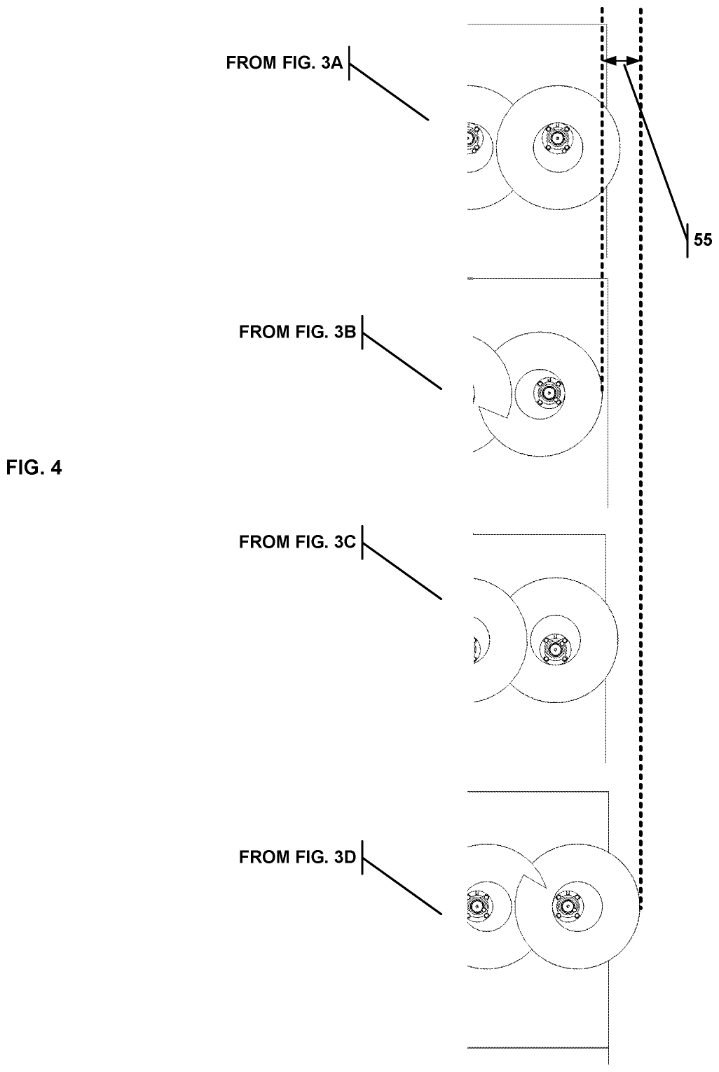

FIGS. 3A-3D show the distal or end view of the disc screen 40. In FIG. 3A, the auger disc rotation axis 20 is below the central longitudinal disc axis 15. In FIG. 3B, the auger disc rotation axis 20 lies to the left of the central longitudinal auger disc axis 15. In FIG. 3C, the auger disc rotation axis 20 lies above the central longitudinal disc axis 15, and in FIG. 3D, the auger disc rotation axis 20 lies to the right of the central longitudinal disc axis 15. All four configurations are possible, and FIG. 4 shows the varying amplitude or displacement 55 associated with the configurations of FIGS. 3A-3D. FIG. 4 also illustrates the movement of a single eccentric auger disc 10, demonstrating the amplitude or displacement 55 difference caused by the eccentricity as the disc 10 rotates (which in the vertical direction causes bouncing or agitation although FIG. 4 only highlights the horizontal displacement 55).

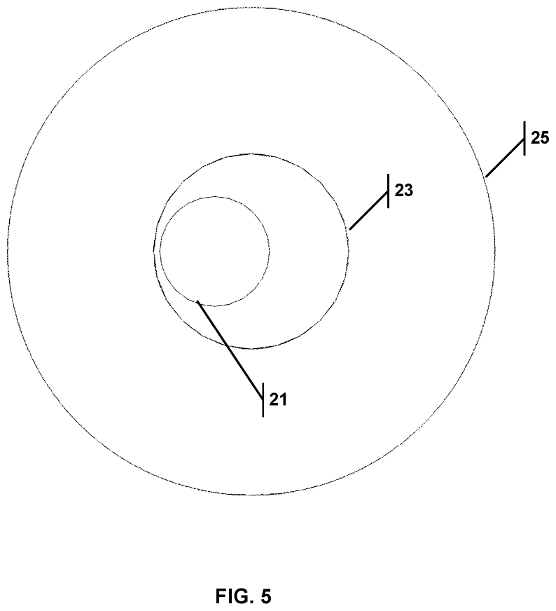

Note that, visible from FIG. 2C, the spacing between discs creates a gap 42. The helical ridge of the first disc forms a gap 42 with the hub surface of the second disc, and when the two discs are rotated in the same direction, the width of the gap is substantially constant. The position of the gap moves along the direction 44 of the longitudinal axis of the first disc in the disc screen 40. FIG. 5 shows the discharge end of the disc, with the outermost circle being the helical ridge 25, and middle circle being the circular hub 22 and the innermost non-concentric circle being the bearing mount for the disc axis of rotation 21. Thus, the position of the gap formed between the first and second discs may be constant as the gap moves longitudinally from the mount or drive end toward the discharge or distal end.

The helical ridge for each disc extends away from the hub surface at a height 26, and the height is constant for the length of the helical ridge. Thus, the absolute position of the helical ridge that contacts the material to be sorted may change, and the position of the hub surface changes in the longitudinal direction with the novel eccentric auger disc described in the present invention. This tends to create a bouncing motion or agitation, which can serve to increase sorting efficiency and allow the auger disc screen 40 to be able to sort larger materials, relative to prior art.

The agitation or bouncing motion of the disc screen is improved with a non-circular auger disc, as shown in FIGS. 6A and 6B, which show a non-circular auger disc 110 with two lobes, in which there is similarly an axis offset 130 between the central longitudinal auger disc axis 115 and the non-circular auger disc axis of rotation 120. The non-circular hub 122 is enlarged in FIG. 6B to show the hub lobes 135. Of course, it should be obvious to one of skill in the art that other configurations are possible, whereby the hub comprises multiple lobes 135, without departing from the scope and spirit of the present invention.

Traditional auger screens have an issue in that material tends to be poorly distributed across the disc screen deck. Because the disc screen has conveyance in two directions, in the forward direction caused by the rotation of the outer edges of the helical ridge and in the side direction caused by pushing from the helical ridge conveyors, a triangular pattern of material tends to form on the deck, with half the screening deck uncovered and unutilized.

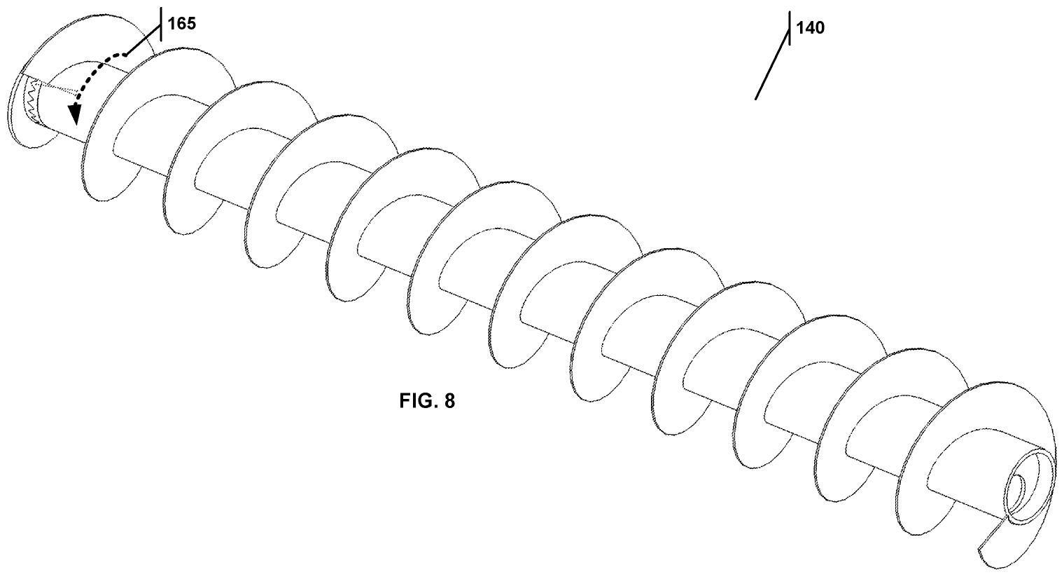

However, a non-round hub, as disclosed herein, particularly in FIGS. 6A-B, creates a bumping and lifting action underneath material trapped in this pocket. This bouncing motion, when combined with inclination (shown in FIGS. 6-8), can induce material to bounce out of its current pocket to a pocket further inside the disc screen. This helps mitigate the side conveyance effect and reduces the triangular nature of the spread, increasing screen deck utilization and keeping material more centered on the disc screen, which has a further benefit of rendering the gathering of material easier.

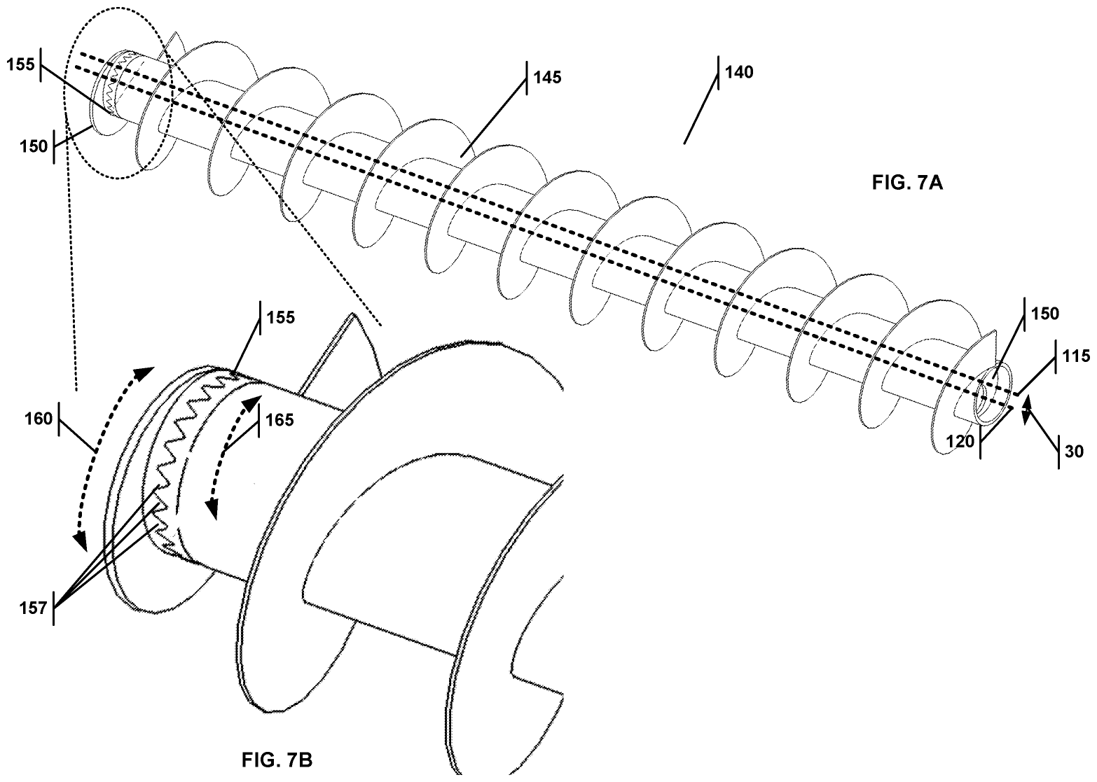

In a typical auger screen, the opening size of the gap between discs can be changed by changing the rotational position of one auger relative to the next. This is typically accomplished by breaking open the roller chain, rotating one auger in place, and reattaching the roller chain. The ability to change the opening size of the gap between auger discs allows for fine adjustment of the separation process in the field. However, breaking open the roller chain and reattaching the roller chain takes quite a bit of effort and time, and the novel auger disc 140 presented in FIGS. 7A-15 and any novel auger disc screen 40 utilizing such an auger disc with a two-concentric shaft design 140 would have the added benefit of having an easier process to adjust the opening size of the gap.

As shown in FIG. 7A, the auger disc with a two-concentric shaft design 140 is comprised of an inner shaft 150, as well as an outer auger shaft 145 constructed to slide over a portion of the inner shaft 150, the outer shaft 145 comprise the hub, and a self-aligning spline 155 that forms a detachable connection between the inner shaft 150 and the outer shaft 145. Remember that with an eccentric auger, the rotational position also determines displacement of the shaft. By dividing the eccentric auger into two shafts, two degrees of freedom can be achieved. The inner shaft 150 determines the first degree of freedom 160 adjustment that determines the displacement of the shaft. The outer shaft 145 determines the rotational position of the flights or helical ridge structures 25, as a second degree of freedom adjustment 165. The inner shaft 150 and the outer auger shaft 145 are connected with a self-aligning spline 155, which in FIGS. 7A-7B is shown as a Hirth spline, at the drive or mount end of the disc. It would be apparent to those skilling in the art that other detachable connection structures/splines may be used without departing from this disclosure. Depending on the rotational positions of the inner shaft 150 and the outer auger shaft 145, and on how the self-aligning spline 155 joins the two shafts (145, 150) together, there may be a plurality of relative rotational positions 157 that may be adjustable and available. The self-aligning spline 155 is constructed to allow the outer auger shaft 145 to be detachably fixed to the inner shaft 150 in one of a plurality of relative rotational positions 157, as seen in FIG. 7B.

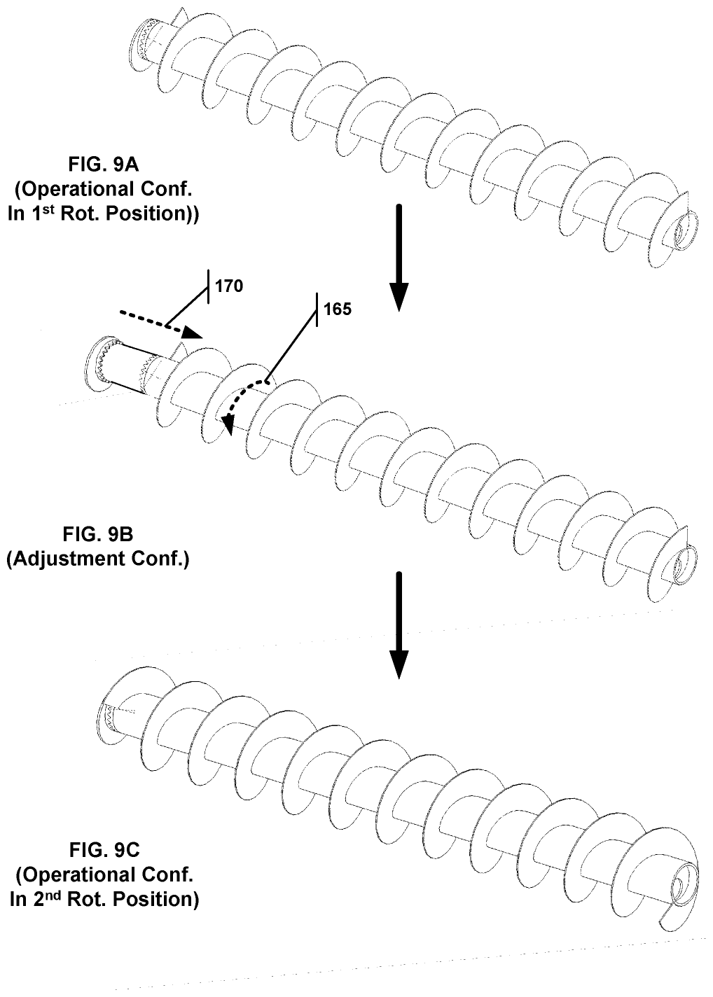

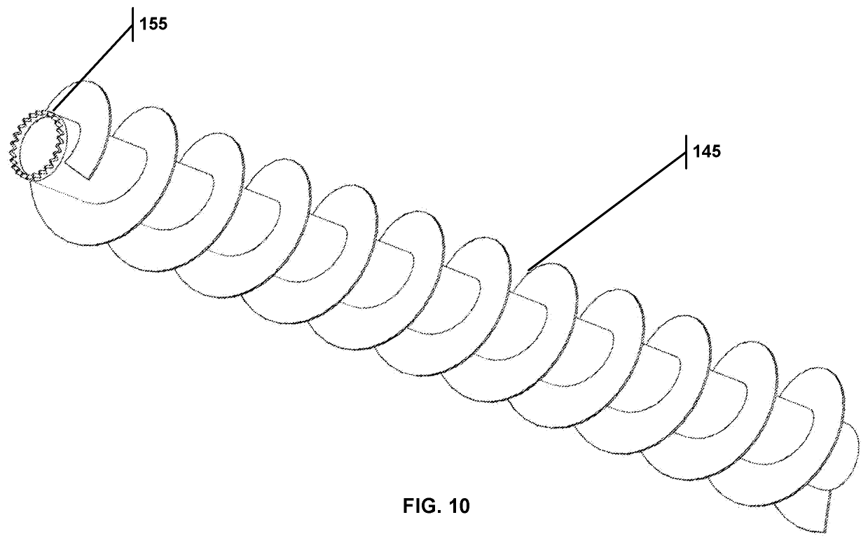

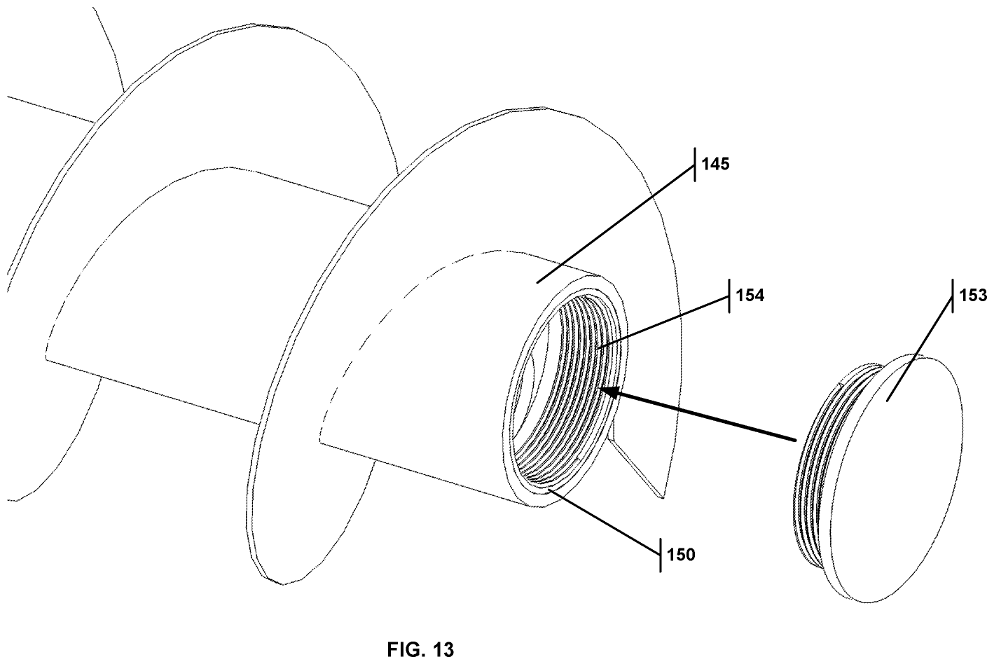

While an auger disc with a two-concentric shaft design 140 can have the inner and outer shafts connected together with a self-aligning spline 155 at the mount or drive end, at the discharge or distal end fasteners are used (see fastener 153 in FIGS. 13-15). A disc screen may use at least one auger disc with a two-concentric shaft design 140 as described above. The two-concentric shaft design 140 may be in an operational mode in a first rotational position (FIG. 9A), then in an adjustment configuration (FIG. 9B) which allows the user to change the opening size of the gap in such a disc screen. In the adjustment configuration, a fastener (not shown) can be removed from the novel auger disc 140 at the distal end, the outer auger shaft 145 can slide (along direction 170) to disengage the spline 155 (only needs to be pulled out by a small longitudinal distance, perhaps one inch, not entirely pulled out and off of the inner shaft), the outer auger shaft 145 can be rotated (along direction 165) as desired, slid back (along direction 170) to engage the self-aligning spline 155, and then the fasteners (not shown) can be reattached, returning the two-concentric shaft design 140 to an operational mode in a second rotational position (FIG. 9C). This is done from the distal end of the disc, and does not require breaking any chains, so it is faster and easier to do. A disc screen employing such a two-concentric shaft design auger disc 140 may use one or more of these auger discs. FIGS. 9A-9C thus show that the self-aligning spline of the auger disc in the disc screen is constructed to allow the outer auger shaft to be detachably fixed to the inner shaft in one of a plurality of relative rotational positions. Changing the opening size of the gap between the adjacent auger discs in the disc screen is therefore quick and easy compared with prior art.

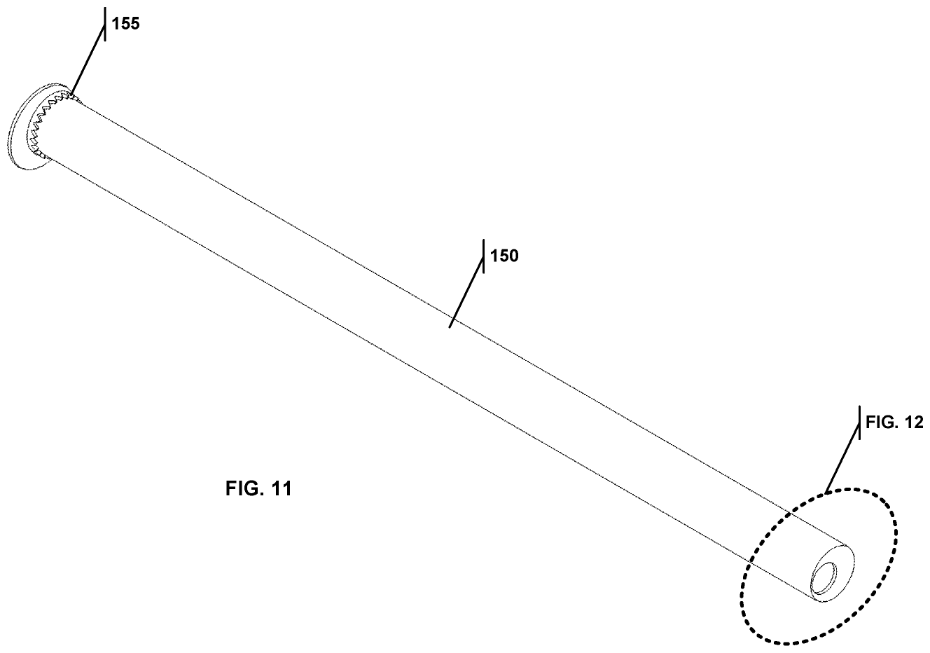

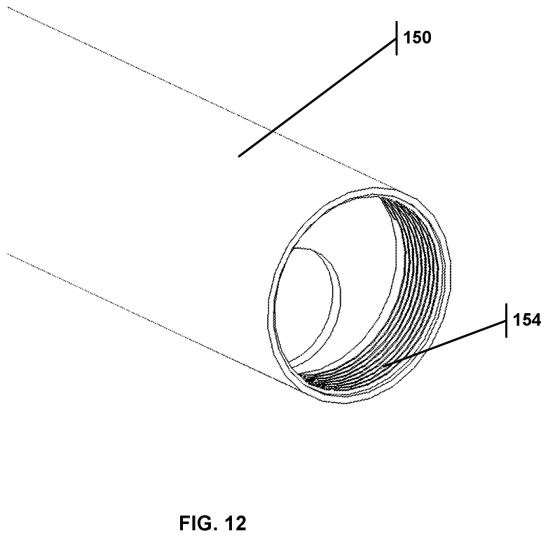

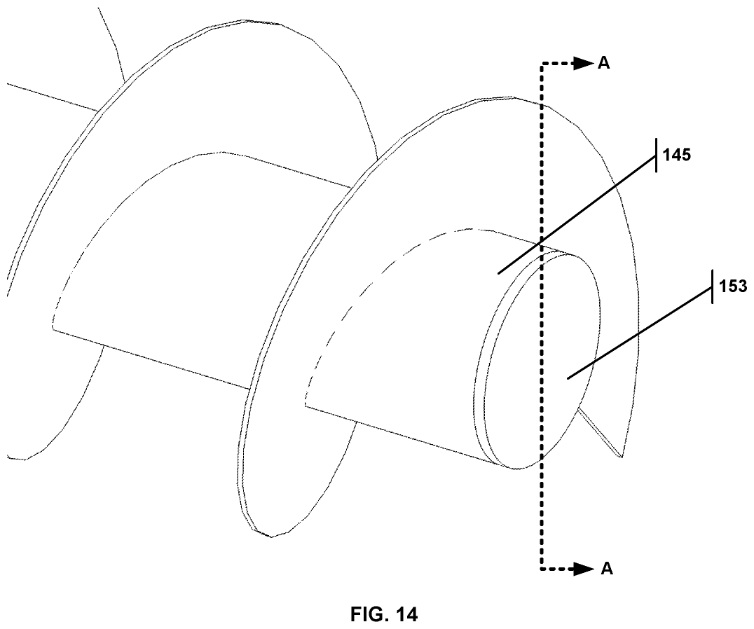

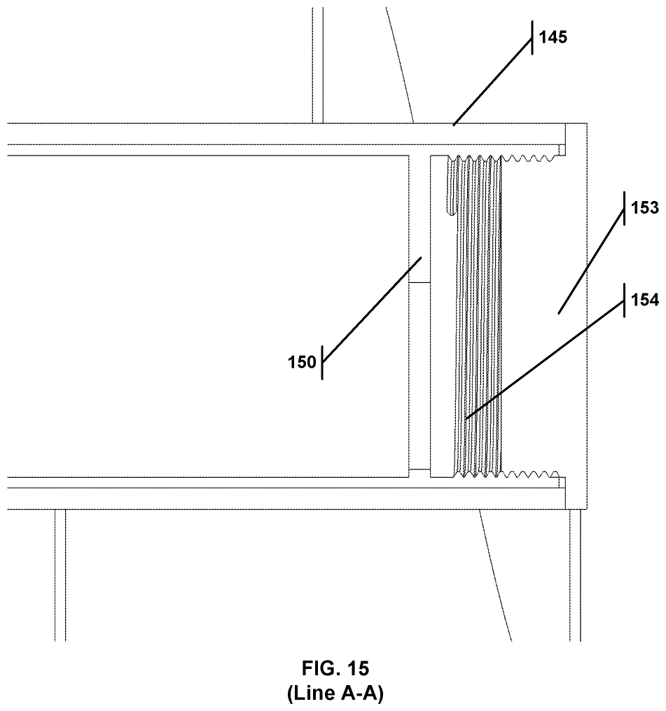

FIG. 10 presents an isometric view of just the outer auger shaft 145 towards the mount or drive end, with the self-aligning spline 155 visible. FIG. 11 presents an isometric view of just the inner shaft 150 towards the discharge or distal end, with the self-aligning spline 155 visible. An enlarged view of the inner shaft 150 at the distal end is shown in FIG. 12. FIG. 12 shows that at the distal end, the inner shaft 150 may have threading 154 for a fastener, a stop, or a plug. FIG. 13 shows the inner shaft 150 and the outer auger shaft 145 at the distal end when they are joined together by the self-aligning spline 155 (not shown). FIG. 13 shows how the stop/fastener/plug 153 can fit into the threading 154. The stop/fastener/plug 153 would restrict the outer auger shaft 145 from sliding in the longitudinal direction (i.e., direction along 170) relative to the inner shaft 150, and the stop/fastener/plug 153 can be threaded onto the inner shaft 150. FIG. 14 shows the stop/fastener/plug 153 screwed into the threading 154, so that the two concentric shafts are detachably fixed when the stop 153 is in place. A cross-section drawn along the line A-A of FIG. 14 is shown is FIG. 15. Here, the stop/fastener/plug 153 restricts the sliding of the outer auger shaft 145 over the inner shaft 150 in the direction of 170.

FIGS. 14 and 15 show the novel auger disc 140 in an operational configuration, where the stop/fastener/plug 153 restricts the outer auger shaft 145 from sliding relative to the inner shaft 150, thereby fixing the outer auger shaft to the inner shaft in a first of the plurality of relative rotational positions. FIGS. 9B and 13 show the auger disc in an installation or adjustment configuration where the stop/fastener/plug 153 is released to allow the outer auger shaft 145 to slide relative to the inner shaft 150, thereby allowing the outer auger shaft 145 to be rotated to a second of the plurality of relative rotational positions. The auger disc 140 with these two configurations can be incorporated into a disc screen 40 to provide a better means of adjusting the opening size of the gap of the disc screen 40 compared to the prior art.

In summary, FIGS. 1A-6B present a novel eccentric auger disc for use in a disc screen, which solves some of the problems encountered in the prior art. FIGS. 7-15 present an auger disc that is designed from two concentric shafts instead of one. In the embodiment of FIGS. 7-15, the auger disc for use in a disc screen comprises a central longitudinal disc axis 115, an inner shaft 150 that runs along the central longitudinal axis 115, an outer auger shaft 145 constructed to slide over a portion of the inner shaft 150, the outer shaft 145 comprising a hub, wherein the hub comprises a hub surface 123 and a helical ridge structure 125 extending away from the hub surface 123 and twisting about the longitudinal axis 115 at least 360 degrees, and a self-aligning spline 155 forming a detachable connection between the inner shaft 150 and the outer shaft 145. The self-aligning spline 155 can be constructed to allow the outer auger shaft 145 to be detachably fixed to the inner shaft 150 in one of a plurality of relative rotational positions. The auger disc 140 can further comprise a stop 153 that restricts the outer auger shaft 145 from sliding relative to the inner shaft 150. The stop 153 is optionally, but not necessarily, threaded onto the inner shaft 150. The auger disc 140 has two configurations: an operational configuration where the stop restricts the outer auger shaft 145 from sliding relative to the inner shaft 150, thereby fixing the outer auger shaft 145 to the inner shaft 150 in a first of the plurality of relative rotational positions; and an adjustment configuration where the stop is released to allow the outer auger shaft 145 to slide relative to the inner shaft 150, thereby allowing the outer auger shaft 145 to be rotated to a second of the plurality of relative rotational positions.

The invention has been described in connection with specific embodiments that illustrate examples of the invention but do not limit its scope. Various example systems have been shown and described having various aspects and elements. Unless indicated otherwise, any feature, aspect or element of any of these systems may be removed from, added to, combined with or modified by any other feature, aspect or element of any of the systems. As will be apparent to persons skilled in the art, modifications and adaptations to the above-described systems and methods can be made without departing from the spirit and scope of the invention, which is defined only by the following claims. Moreover, the applicant expressly does not intend that the following claims “and the embodiments in the specification to be strictly coextensive.” Phillips v. AHW Corp., 415 F.3d 1303, 1323 (Fed. Cir. 2005) (en banc).

1. An auger disc (10, 110) for use in a disc screen (40) comprising:
a central longitudinal disc axis (15, 115);
a hub (22, 122) extending a length along the longitudinal disc axis, the longitudinal disc axis is coaxial with the center of the hub, the hub further comprising:
a hub surface (23, 123);
a helical ridge structure (25, 125) extending away from the hub surface and twisting about the longitudinal axis at least 360 degrees (35); and
a disc rotation axis (20, 120) that is parallel to the central longitudinal axis and offset (30, 130) from the center of the hub;
wherein the disc is constructed to rotate about the disc rotation axis.

2. The disc of claim 1, wherein the hub is circular (22).

3. The disc of claim 1, wherein the hub is non-circular (122).

4. The disc of claim 3, wherein the hub comprises multiple lobes (135).

5. The disc of claim 1, wherein the helical ridge extends away from the hub surface at a height (26), and the height is constant for the length of the helical ridge.

6. The disc of claim 1, further comprising:
an inner shaft (150);
an outer auger shaft (145) constructed to slide over a portion of the inner shaft, the outer shaft comprising the hub;
a self-aligning spline (155) forming a detachable connection between the inner shaft and the outer shaft.

7. The disc of claim 6, wherein the self-aligning spline is constructed to allow the outer auger shaft to be detachably fixed to the inner shaft in one of a plurality of relative rotational positions.

8. The disc of claim 7, further comprising a stop (153) that restricts the outer auger shaft from sliding relative to the inner shaft.

9. The disc of claim 7, wherein the stop is threaded onto the inner shaft.

10. The disc of claim 8, wherein the disc has two configurations:
an operational configuration where the stop restricts outer auger shaft from sliding relative to the inner shaft thereby fixing the outer auger shaft to the inner shaft in a first of the plurality of relative rotational positions; and
an adjustment configuration where the stop is released to allow the outer auger shaft to slide relative to the inner shaft, thereby allowing the outer auger shaft to be rotated to a second of the plurality of relative rotational positions.

11. A disc screen (40) comprising;
a first and second adjacent auger discs, each disc comprising:
a central longitudinal disc axis (15, 115);
a hub (22, 122) extending a length along the longitudinal disc axis, the longitudinal disc axis is coaxial with the center of the hub, the hub further comprising:
a hub surface (23, 123);
a helical ridge structure (25, 125) extending away from the hub surface and twisting about the longitudinal axis at least 360 degrees (35); and
a disc rotation axis (20, 120) that is parallel to the central longitudinal axis and offset (30, 130) from the center of the hub;
wherein the disc is constructed to rotate about the disc rotation axis.
wherein the helical ridge structure from the first disc is interleaved with the helical ridge structure of the second disc (52).

12. The disc screen of claim 11, wherein the helical ridge of the first disc forms a gap (42) with the hub surface of the second disc, and when the two discs are rotated in the same direction, the width of the gap is substantially constant.

13. The disc screen of claim 12, wherein the position of the gap moves along the direction (44) of the longitudinal axis of the first disc.

14. The disc screen of claim 12, wherein the position of the gap relative to the center of the hub of the first disc is not substantially constant.

15. The disc screen of claim 11, wherein the helical ridge for each disc extends away from hub surface at a height (26), and the height is constant for the length of the helical ridge.

16. The disc screen of claim 11, wherein the first auger disc comprising:
an inner shaft (150);
an outer auger shaft (145) constructed to slide over a portion of the inner shaft, the outer shaft comprising the hub of the first auger disc;
a self-aligning spline (155) forming a detachable connection between the inner shaft and the outer shaft.

17. The disc screen of claim 16 wherein the self-aligning spline is constructed to allow the outer auger shaft to be detachably fixed to the inner shaft in one of a plurality of relative rotational positions.

18. The disc screen of claim 17, further comprising a stop (153) that restricts the outer auger shaft from sliding relative to the inner shaft.

19. The disc screen of claim 17, wherein the stop is threaded onto the inner shaft.

20. The disc screen of claim 18, wherein the first disc has two configurations:
an operational configuration where the stop restricts the outer auger shaft from sliding relative to the inner shaft thereby fixing the outer auger shaft to the inner shaft in a first of the plurality of relative rotational positions; and
an adjustment configuration where the stop is released to allow the outer auger shaft to slide relative to the inner shaft, thereby allowing the outer auger shaft to be rotated to a second of the plurality of relative rotational positions.

21. An auger disc for use in a disc screen comprising:
a central longitudinal disc axis (15, 115);
an inner shaft (150) that runs along the central longitudinal axis;
an outer auger shaft (145) constructed to slide over a portion of the inner shaft, the outer shaft comprising a hub, wherein the hub comprises a hub surface (23, 123) and a helical ridge structure (25, 125) extending away from the hub surface and twisting about the longitudinal axis at least 360 degrees (35); and
a self-aligning spline (155) forming a detachable connection between the inner shaft and the outer shaft.

22. The disc of claim 21 wherein the self-aligning spline is constructed to allow the outer auger shaft to be detachably fixed to the inner shaft in one of a plurality of relative rotational positions.

23. The disc of claim 22, further comprising a stop (153) that restricts the outer auger shaft from sliding relative to the inner shaft.

24. The disc of claim 23, wherein the stop is threaded onto the inner shaft.

25. The disc of claim 23, wherein the disc has two configurations:
an operational configuration where the stop restricts the outer auger shaft from sliding relative to the inner shaft thereby fixing the outer auger shaft to the inner shaft in a first of the plurality of relative rotational positions; and
an adjustment configuration where the stop is released to allow the outer auger shaft to slide relative to the inner shaft, thereby allowing the outer auger shaft to be rotated to a second of the plurality of relative rotational positions.
